(19) United States
(12) Patent Application Publication
(10) Pub. No.: US 2008/0310384 A1
(43) Pub. Date: Dec. 18, 2008

(54) Ranging apparatus and method in a wireless mobile communication system

(75) Inventors: Jae-Jeong Shim, Seongnam-si (KR); Won-Il Roh, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/214,016

(22) Filed: Jun. 16, 2008

(30) Foreign Application Priority Data
Jun. 15, 2007 (KR) 58990/2007

(51) Int. Cl. H04J 13/00

(52) U.S. Cl. 370/342

(57) ABSTRACT

A ranging apparatus and method of a mobile station in a wireless mobile communication system are provided, in which the mobile station completes a code-based ranging with a base station, transmits a ranging request message to the base station, increases a first count by 1 if the mobile station fails to receive a response message to the ranging request message from the base station, requests a code-based ranging with the base station if the increased first count is less than or equal to a predetermined first threshold, increases the first count by 1 if the mobile station fails to receive a response message to the code-based ranging request from the base station, and repeats the code-based ranging request and increases the first count by 1 for each of the code-based ranging requests that the mobile station fails to receive a response message from the base station until the first count exceeds the first threshold.

### CROSS-REFERENCE TO RELATED APPLICATION(S) AND CLAIM OF PRIORITY

This application claims the benefit under 35 U.S.C. §119(a) of a Korean Patent Application filed in the Korean Intellectual Property Office on Jun. 15, 2007 and assigned Serial No. 2007-58990, the entire disclosure of which is hereby incorporated by reference.

### TECHNICAL FIELD OF THE INVENTION

The present invention generally relates to a wireless mobile communication system. More particularly, the present invention relates to a ranging apparatus and method of a mobile station (MS) in a wireless mobile communication system.

### BACKGROUND OF THE INVENTION

Studies have been conducted on providing services with different Quality of Service (QoS) requirements to users at or above 100 Mbps in future-generation wireless mobile communication systems.

One of the future-generation wireless mobile communication systems is Institute of Electrical and Electronics Engineers (IEEE) 802.16. The IEEE 802.16 communication system operate using Orthogonal Frequency Division Multiple Access (OFDMA). In the OFDMA communication system, an MS performs ranging with a base station (BS). Ranging is a process of acquiring time synchronization and adjusting frequency and transmit power between the MS and the BS.

Ranging can be classified as either using a Code Division Multiple Access (CDMA) code or using a Medium Access Control (MAC) management message. Also, four ranging modes are defined: initial ranging, periodic ranging, bandwidth request ranging, and handover ranging.

Conventionally, upon receipt of a ranging request using a CDMA code from the MS, the BS replies to the MS. The MS then requests ranging to the BS by a MAC management message, and the BS responds to the ranging request.

A situation may occur in which the CDMA code ranging is successful, and the MAC management message ranging fails. In this case, the MS can request ranging by the CDMA code up to an allowed number of times as defined in Table 1 below by an IEEE 802.16 standard.

TABLE 1

| | | | | | |
|---|---|---|---|---|---|
| | | Time | Minimum | Default | Maximum |
| System | Name | reference | value | value | value |

| | | | |
|---|---|---|---|
| MS | Contention | Number of | 16 |
| | Ranging | retries on | |
| | Retries | contention | |
| | | Ranging | |
| | | Requests | |

Even if the MS succeeds in contention-based ranging using a CDMA code, when the MS fails in ranging using a MAC management message, the MS requests ranging using the CDMA code up to 16 times.

As a result, much time is taken for the ranging procedure. A low QoS is provided to a user, especially when the ranging procedure takes a long time during a handover of the MS.

### SUMMARY OF THE INVENTION

To address the above-discussed deficiencies of the prior art, it is a primary object of the present invention to address at least the problems and/or disadvantages and to provide at least the advantages described below. Accordingly, an aspect of exemplary embodiments of the present invention is to provide an apparatus and method for reducing time required to perform ranging in a wireless mobile communication system.

In accordance with an aspect of exemplary embodiments of the present invention, there is provided a ranging method of an MS in a wireless mobile communication system, in which the MS completes a code-based ranging with a BS, transmits a ranging request message to the BS, increases a first count by 1 if the MS fails to receive a response message to the ranging request message from the BS, requests a code-based ranging with the BS if the increased first count is less than or equal to a predetermined first threshold, increases the first count by 1 if the MS fails to receive a response message to the code-based ranging request from the BS, and repeats the code-based ranging request and increases the first count by 1 for each of the code-based ranging requests that the mobile station fails to receive a response message from the base station until the first count exceeds the first threshold.

In accordance with another aspect of exemplary embodiments of the present invention, there is provided a ranging method of an MS in a wireless mobile communication system, in which the MS requests a code-based ranging with a BS, activates a first timer simultaneously with the code-based ranging request, retries the code-based ranging request as many times as a first threshold and re-activating the first timer at each retry if the MS fails to receive a code-based ranging response message from the BS, transmits a ranging request message to the BS if the MS has received a response message to one of the code-based ranging request and the retries until the first timer expires, activates a second timer simultaneously with the transmission of the ranging request message, retries the code-based ranging request as many times as a second threshold less than the first threshold and re-activating the second timer at each retry if the MS fails to receive a response message to the ranging request message from the BS, and performs a basic capability negotiation with the BS if the MS has received a response message to one of the code-based ranging request and the retries until the second timer expires.

In accordance with a further aspect of exemplary embodiments of the present invention, there is provided an apparatus of an MS in a wireless mobile communication system, in which a controller activates a timer simultaneously with a transmission of a ranging request message, and a first count controller increases a first count by 1 under control of the controller if the MS fails to receive a response message to the ranging request message before the expiration of the timer.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flowchart illustrating a ranging operation of an MS according to the present invention;

FIG. 2 is a diagram illustrating a signal flow for a ranging procedure according to an exemplary embodiment of the present invention; and

FIG. 3 is a block diagram of the MS according to an exemplary embodiment of the present invention.

### DETAILED DESCRIPTION OF THE INVENTION

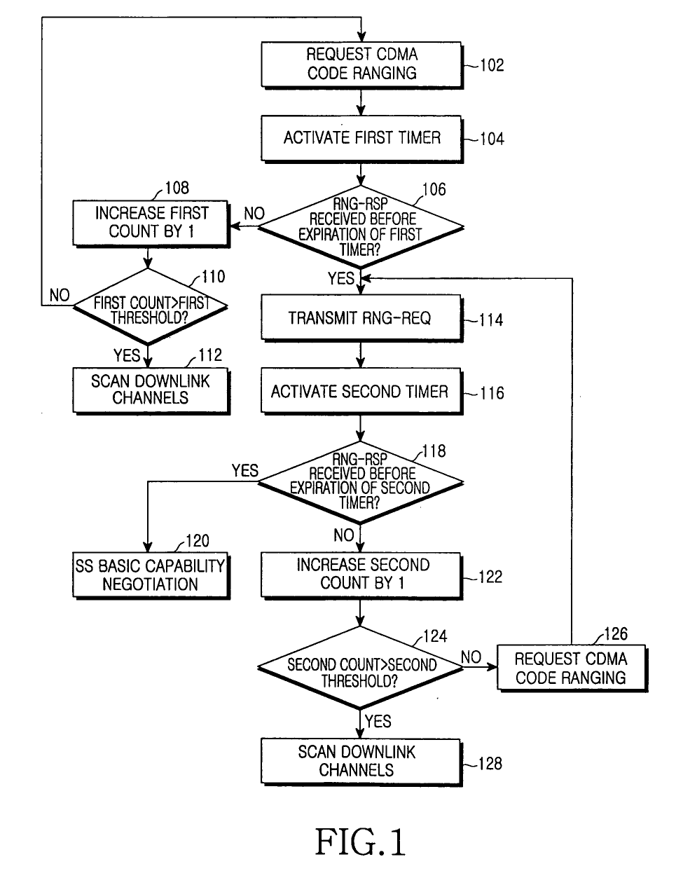

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Exemplary embodiments of the present invention provide an apparatus and method for reducing the time required to perform ranging in a wireless mobile communication system. According to the present invention, ranging can be initial ranging, periodic ranging, bandwidth request ranging, or handover ranging.

FIG. 1 is a flowchart illustrating a ranging operation of an MS according to the present invention.

Referring to FIG. 1, the MS requests ranging by transmitting a CDMA code to a BS in step 102. The ranging request is for synchronization acquisition and bandwidth allocation requesting. In step 104, the MS activates a first timer simultaneously with the transmission of the ranging request. If the MS has not received a ranging response (RNG-RSP) from the BS before the first timer expires in step 106, the MS proceeds to step 108. Upon receipt of the RNG-RSP message before the expiration of the first timer, the MS proceeds to step 114.

In step 108, the MS increases a first count by 1. The first count increases each time the MS requests ranging using a CDMA code. A second count that will be described later is different from the first count. The second count increases when the MS requests ranging using a CDMA code again in the case where it has succeeded in CDMA code ranging but failed in message ranging in accordance with the present invention.

The MS compares the first count with a predetermined first threshold in step 110. The first threshold is a maximum number of CDMA code ranging requests that the MS can transmit. A second threshold that will be described later is different from the first threshold. The second threshold is a maximum number of CDMA code ranging requests that the MS can retry in the case where it has succeeded in CDMA code ranging but failed in message ranging in accordance with the present invention. For example, the first threshold can be 16 and the second threshold can be 3. If the first count exceeds the first threshold, the MS scans downlink channels that will perform ranging in step 112. If the first count is less than or equal to the first threshold, the MS returns to step 102.

Meanwhile, upon receipt of the RNG-RSP message for the CMDA code ranging from the BS, the MS transmits a ranging request (RNG-REQ) message to the BS in step 114. The MS finds out a bandwidth in which to transmit the RNG-REQ message from the RNG-RSP message. The MS then activates a second timer in step 116. The second timer may be identical to or different from the first timer. For example, if a message ranging procedure is to be performed fast according to system implementation, the second timer can be set to a shorter time than the first timer.

Upon receipt of an RNG-RSP message before the expiration of the second timer in step 118, the MS goes to step 120. If the MS has not received the RNG-RSP message before the expiration of the second timer in step 118, the MS goes to step 122.

The MS performs a subscriber station (SS) basic capability (SBC) negotiation procedure with the BS in step 120.

On the other hand, the MS increases the second count by 1 in step 122 and compares the second count with the second threshold in step 124. If the second count exceeds the second threshold, the MS scans downlink channels in step 128. If the second threshold is less than or equal to the second threshold, the MS requests CDMA code ranging in step 126 and returns to step 114. After step 126, a third timer different from the second timer can be activated in step 116.

Table 2 illustrates the second threshold proposed in the present invention.

TABLE 2

| | | | | | |
|---|---|---|---|---|---|
| | | Time | Minimum | Default | Maximum |
| System | Name | reference | value | value | value |

| | | | |
|---|---|---|---|
| MS | Ranging | Number of | 3 |
| | Request | retries on | |
| | Retries | Ranging | |
| | | Requests by | |
| | | RNG-REQ | |
| | | messages | |
| | | (OFDMA only) | |

As described above, the new second threshold is different from the first threshold. The second threshold is less than the first threshold. Thus, in the case where the MS has succeeded in CDMA code ranging but failed in message ranging, it retries ranging according to the second threshold. Hence, ranging is fast in the present invention. In comparison, the MS conventionally retries ranging according to the first threshold in the same situation. As a result, ranging takes a long time.

Also, the new second and third timers are set to a shorter time than the conventional first timer. The second timer and the third timer have time values set for fast ranging in the case where the MS has succeeded in CDMA code ranging but failed in message ranging.

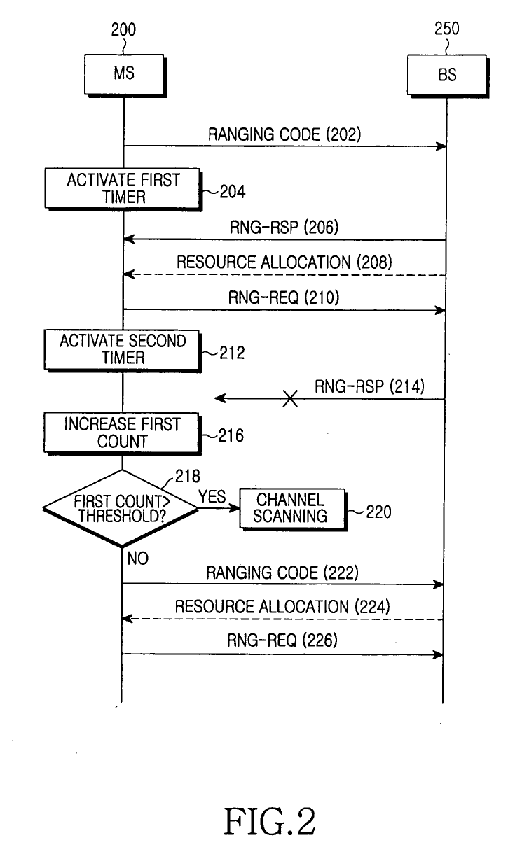

FIG. 2 is a diagram illustrating a signal flow for a ranging procedure according to an exemplary embodiment of the present invention.

Referring to FIG. 2, an MS 200 transmits a ranging code to a BS 250 in step 202 and at the same time, activates the first timer in step 204. The BS 250 transmits an RNG-RSP message to the MS 200 before expiration of the first timer in step 206. Then the BS 250 can allocate resources to the MS 200 in step 208 so that the MNS 200 can transmit an RNG-REQ message in step 210.

The MS 200 transmits the RNG-REQ message to the BS 250 in step 210 using the allocated resources in step 208 and simultaneously activates the second timer in step 212. If the MS 200 has not received an RNG-RSP message from the BS 250 before the expiration of the second timer in step 214, it increases a count (i.e. the second count described with reference to FIG. 1) by 1 in step 216. In step 218, the MS 200 compares the increased count with a threshold. If the increased count exceeds the threshold, the MS scans downlink channels in step 220. On the other hand, if the increased count is less than or equal to the threshold, the MS 200 transmits a ranging code to the BS 250 in step 222. Then the MS 200 is allocated resources by the BS 250 in step 224 and transmits an RNG-REQ message to the BS 250 in step 226 using the allocated resources in step 224.

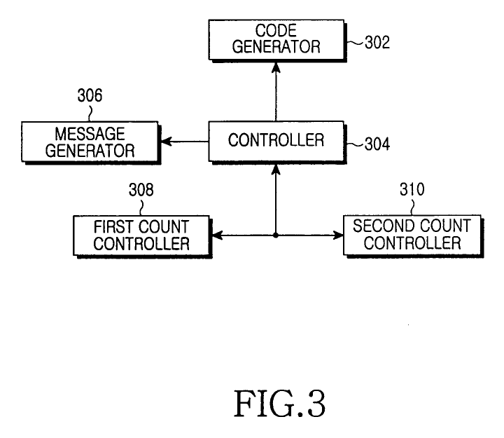

FIG. 3 is a block diagram of the MS according to an exemplary embodiment of the present invention.

Referring to FIG. 3, a code generator 302 generates a CDMA ranging code under the control of a controller 304. The controller 304 controls the code generator 302, a message generator 306, a first count controller 308, and a second count generator 310. It also controls activation of the first and second timers described with reference to FIG. 1 and controls an operation corresponding to expiration of each timer. For example, the controller 304 controls steps 112, 120 and 128 to be performed in FIG. 1.

The message generator 306 generates messages under the control of the controller 304 (for example, an RNG-REQ message). The first count controller 308 increases or resets the first count under the control of the controller 304. The second count controller 310 increases or resets the second count under the control of the controller 304.

As is apparent from the above description, the present invention advantageously enables fast ranging by defining a new threshold in a wireless mobile communication system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A ranging method of a mobile station in a wireless mobile communication system, comprising:
completing a code-based ranging with a base station;
transmitting a ranging request message to the base station;
increasing a first count by 1 if the mobile station fails to receive a response message to the ranging request message from the base station;
requesting a code-based ranging with the base station if the increased first count is less than or equal to a predetermined first threshold; and
increasing the first count by 1 if the mobile station fails to receive a response message to the code-based ranging request from the base station,
wherein the mobile station repeats the code-based ranging request and increases the first count by 1 for each of the code-based ranging requests that the mobile station fails to receive a response message from the base station until the first count exceeds the first threshold.

2. The ranging method of claim 1, wherein the first count h as an initial value of 0.

3. The ranging method of claim 1, further comprising performing a basic capability negotiation with the base station upon receipt of the response message to the ranging request message from the base station.

4. The ranging method of claim 1, further comprising scanning a downlink channel if the increased first count exceeds the first threshold.

5. The ranging method of claim 1, wherein the first threshold is a maximum number of code-based ranging requests that the mobile station can transmit to the base station when the mobile station has not received the response message to the ranging request message after completing the code-based ranging with the base station.

6. The ranging method of claim 1, wherein completing a code-based ranging with a base station is performed according to a second threshold larger than the first threshold and the second threshold is a maximum number for a code-based ranging request, when the mobile station fails to receive a response message to the code-based ranging request from the base station.

7. A ranging method of a mobile station in a wireless mobile communication system, comprising:
requesting a code-based ranging to a base station;
activating a first timer simultaneously with the code-based ranging request;
retrying the code-based ranging request as many times as a first threshold and re-activating the first timer at each retry if the mobile station fails to receive a code-based ranging response message from the base station;
transmitting a ranging request message to the base station if the mobile station has received a response message to one of the code-based ranging request and the retries until the first timer expires;
activating a second timer simultaneously with the transmission of the ranging request message;
retrying the code-based ranging request as many times as a second threshold less than the first threshold and re-activating the second timer at each retry if the mobile station fails to receive a response message to the ranging request message from the base station; and
performing a basic capability negotiation with the base station if the mobile station has received a response message to one of the code-based ranging request and the retries until the second timer expires.

8. The ranging method of claim 7, wherein the first timer has a different value from the second timer.

9. The ranging method of claim 7, further comprising scanning a downlink channel if the mobile station fails to receive response messages to as many code-based ranging requests as the second threshold.

10. An apparatus of a mobile station in a wireless mobile communication system, comprising:
a controller for activating a timer simultaneously with a transmission of a ranging request message; and
a first count controller for increasing a first count by 1 under control of the controller if the mobile station fails to receive a response message to the ranging request message before the expiration of the timer.

11. The apparatus of claim 10, further comprising:
a message generator for generating the ranging request message under control of the controller;
a code generator for generating a ranging code requesting ranging under control of the controller; and
a second count controller for increasing a second count by 1 under control of the controller if the mobile station has not received a ranging response message for a predetermined time period after transmitting the ranging code.

12. The apparatus of claim 10, wherein the controller performs a basic capability negotiation with a base station if the mobile station has received the response message to the ranging request message before the expiration of the timer.
